(19) United States
(12) Patent Application Publication
(10) Pub. No.: US 2024/0066476 A1
(43) Pub. Date: Feb. 29, 2024

(54) DISPERSING DEVICE AND PULPING MACHINE

(71) Applicant: ONGOAL TECHNOLOGY CO., LTD., Dongguan (CN)

(72) Inventors: Xie WANG, Dongguan (CN); Hailun YANG, Dongguan (CN); Chao YUAN, Dongguan (CN); Xiaobing DAI, Dongguan (CN); Jie HE, Dongguan (CN)

(73) Assignee: ONGOAL TECHNOLOGY CO., LTD., Dongguan (CN)

(21) Appl. No.: 18/502,493

(22) Filed: Nov. 6, 2023

Related U.S. Application Data
(63) Continuation of application No. PCT/CN2023/077009, filed on Feb. 18, 2023.

(30) Foreign Application Priority Data
Aug. 16, 2022 (CN) 202222162265.4

(51) Int. Cl. B01F 23/50; B01F 27/27

(52) U.S. Cl. CPC B01F 23/56; B01F 27/27; B01F 2035/3513

(57) ABSTRACT

Disclosed is a dispersing device, including a first shear device and at least two second shear devices, one of the first shear device and the second shear device is a shear stator and the other is a shear rotor. The first shear device includes a shear inner ring, a shear outer ring and an annular isolation board. The shear inner ring is provided with a plurality of first radial through holes; the shear outer ring is provided to surround outside the shear inner ring, and is provided coaxially with the shear inner ring and connected in linkage with each other; and the shear outer ring is provided with a plurality of third radial through holes. The annular isolation board is located between the shear inner ring and the shear outer ring, and both opposite ends of the annular isolation board form shear receiving grooves, respectively.

### CROSS-REFERENCE TO RELATED APPLICATIONS

This application is a continuation application of International Application No. PCT/CN2023/077009, filed on Feb. 18, 2023, which claims priority to Chinese Patent Application No. 202222162265.4, filed on Aug. 16, 2022. The disclosures of the above-mentioned applications are incorporated herein by reference in their entireties.

### TECHNICAL FIELD

The present application relates to the technical field of dispersing devices, and in particular to a dispersing device and a pulping machine.

### BACKGROUND

At present, with the development of powder technology, more and more ultrafine powders need to be dispersed into a small amount of liquid (liquid is solvent) to form a slurry with high solid content and high viscosity. However, it is difficult to mix the slurry with high solid content and high viscosity evenly, so it is necessary to fully disperse and grind them by equipment to improve the physical properties of the slurry.

Therefore, the existing dispersing device needs to be improved so that it can better disperse the slurry.

### SUMMARY

In order to overcome the defects of the related art, the present application provides a dispersing device that has a larger volume of a dispersing region and a higher shearing efficiency to slurry in the case of the same volume of the pulping machine.

The purpose of the present application is realized through the following technical solutions:
a dispersing device including a first shear device and at least two second shear devices, one of the first shear device and the second shear device is a shear stator and the other is a shear rotor, and the first shear device is rotatable relative to the second shear device;
the first shear device includes a shear inner ring, a shear outer ring and an annular isolation board; the shear inner ring is provided with a plurality of first radial through holes provided at intervals from each other; the shear outer ring is provided to surround outside the shear inner ring, and is provided coaxially with the shear inner ring and connected in linkage with each other; the shear outer ring is provided with a plurality of third radial through holes provided at intervals from each other; the annular isolation board is located between the shear inner ring and the shear outer ring, an inner side of the annular isolation board is connected with the shear inner ring, and an outer side of the annular isolation board is connected with the shear outer ring, so that both opposite ends of the annular isolation board form shear receiving grooves, respectively;
the second shear device has a shear embedded ring, the shear embedded rings of each of the second shear devices are respectively embedded in one of the shear embedded rings, and the shear embedded ring is provided with a plurality of second radial through holes provided at intervals from each other.

In an embodiment, the first shear device is an integrally formed structure.

In an embodiment, the shear embedded ring and the shear inner ring are provided at intervals to form a first connection gap, the shear embedded ring and the shear outer ring are provided at intervals to form a second connection gap, and the first radial through hole, the first connection gap, the second radial through hole, the second connection gap and the third radial through hole are communicated in sequence.

In an embodiment, an inner side of the shear inner ring is connected with a seal ring, and an inner hole of the seal ring is configured to sealingly and interlockingly connect a rotation shaft.

In an embodiment, the second shear device has an annular carrier plate fixedly connected with the shear embedded ring coaxially, and the annular carrier plate is configured to connect a pulping machine to support the shear embedded ring.

In an embodiment, the first shear device is the shear rotor, and the second shear device is the shear stator.

In an embodiment, the plurality of the first radial through holes are evenly distributed on a side wall of the shear inner ring, the plurality of the second radial through holes are evenly distributed on a side wall of the shear embedded ring, and the plurality of the third radial through holes are evenly distributed on a side wall of the shear outer ring.

In an embodiment, the first radial through hole, the second radial through hole and the third radial through hole are all circular hole structure.

A pulping machine is provided, the pulping machine includes a frame, a rotation shaft and the dispersing device, the frame has a shear chamber, the dispersing device is accommodated in the shear chamber, the rotation shaft passes through an inner hole of the first shear device and is drivingly connected with the first shear device, the dispersing device divides the shear chamber into a first chamber, a second chamber and a third chamber connected in sequence, and the first chamber and the third chamber are located at both opposite ends of the seal ring.

Compared with the related art, the beneficial effects of the present application are: when the first shear device and the second shear device rotate relative to each other, the slurry stagnated and circulated between the first shear device and the second shear device can be sheared, thereby fully dispersing the slurry. Two shear receiving grooves are provided at intervals in the axial direction based on the first shear device and one of the shear embedded rings is accommodated in a one-to-one correspondence, so that the dispersing device can enlarged the volume of the dispersing region of the pulping machine as much as possible in the space of equal volume to increase production capacity of the pulping machine. In addition, according to common knowledge in the art, the larger the volume of the dispersing region of the pulping machine, the longer the residence time of the slurry in the dispersing region, thus facilitating the dispersing device to shear the slurry more fully, so as to further improve the mixing degree of the powder material and the slurry, that is, to further improve the performance of the slurry.

### BRIEF DESCRIPTION OF THE DRAWINGS

FIG. 1 is a structural schematic view of a dispersing device according to the present application.

FIG. 2 is a structural schematic view of a first shear device of the dispersing device of FIG. 1.

FIG. 3 is a structural schematic view of a second shear device of the dispersing device of FIG. 1.

FIG. 4 is a structural schematic view of a pulping machine according to the present application; where an arrow with a solid line is the flow direction of a powder material, and an arrow with a dotted line is the flow direction of the liquid (i.e., solvent).

### DETAILED DESCRIPTION OF THE EMBODIMENTS

The present application is further described below in conjunction with the accompanying drawings and specific embodiments. It should be noted that, on the premise of no conflict, the various embodiments or the various technical features described below can be combined arbitrarily to form new embodiments.

It should be noted that when an element is referred to as being “fixed” to another element, it can be directly on another element, or there can also be an intervening element. When an element is referred to as being “connected” to another element, it can be directly connected to another element or there may be an intervening element. The terms “vertical”, “horizontal”, “left”, “right” and similar expressions used herein are only for illustrative purposes and not intended to be the only implementation.

Unless otherwise defined, all technical terms and scientific terms used herein have the same meanings as those commonly understood by person skilled in the technical field of the present application. The terms used in the description of the present application herein are only for the purpose of describing specific embodiments, and are not intended to limit the present application. The term “and/or” used herein includes any and all combinations of one or more of the associated listed items.

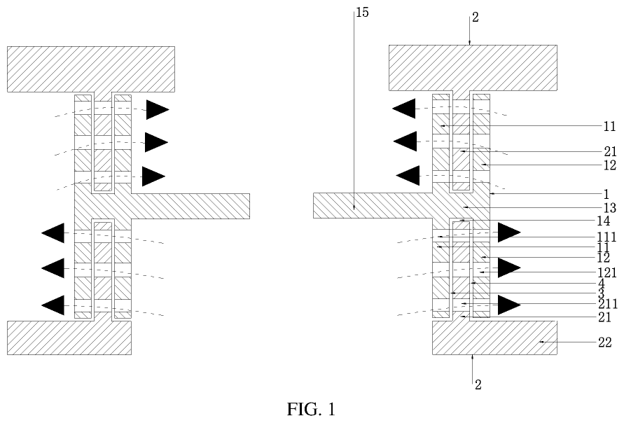

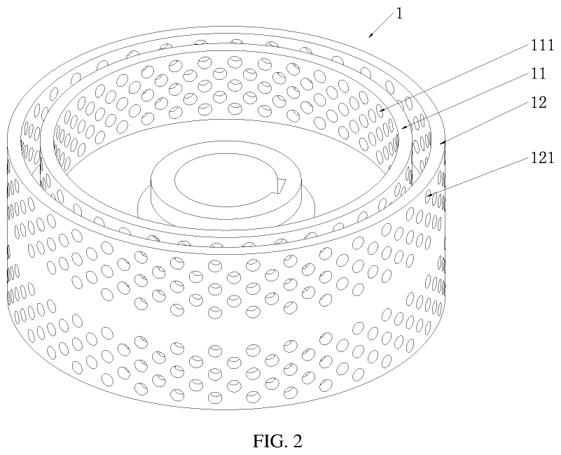

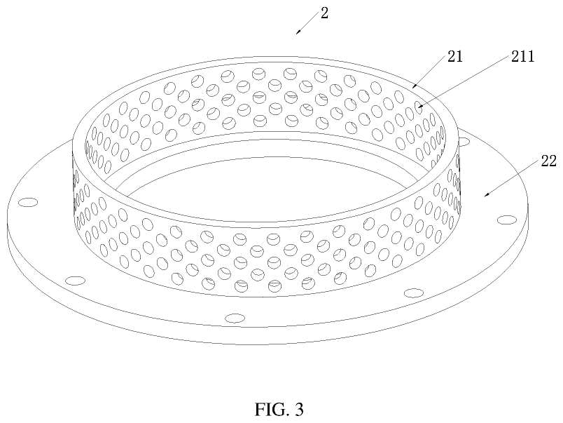

FIG. 1 to FIG. 3 show a dispersing device according to an embodiment of the present application. The dispersing device includes a first shear device 1 and at least two second shear devices 2, one of the first shear device 1 and the second shear device 2 is a shear stator, and the other is a shear rotor. The first shear device 1 is rotatable relative to the second shear device 2 to shear the slurry, thereby fully dispersing the slurry and improving the mixing degree of the slurry, that is, improving the performance of the slurry.

The first shear device 1 includes a shear inner ring 11, a shear outer ring 12 and an annular isolation board 13. The shear inner ring 11 is provided with a plurality of first radial through holes 111, and the plurality of the first radial through holes 111 are provided at intervals from each other. The shear outer ring 12 is provided to surround outside the shear inner ring 11, and is provided coaxially with the shear inner ring 11 and connected in linkage with each other. The shear outer ring 12 is provided with a plurality of third radial through holes 121, and the plurality of the third radial through holes 121 are provided at intervals from each other. The annular isolation board 13 is located between the shear inner ring 11 and the shear outer ring 12, an inner side of the annular isolation board 13 is connected with the shear inner ring 11, and an outer side of the annular isolation board 13 is connected with the shear outer ring 12, so that both opposite ends of the annular isolation board 13 form shear receiving grooves 14, respectively.

The second shear device 2 has a shear embedded ring 21, and the shear embedded rings 21 of each second shear device 2 are respectively embedded in one of the shear embedded rings 21. The shear embedded ring 21 is provided with a plurality of second radial through holes 211, and the plurality of the second radial through holes 211 are provided at intervals from each other.

In this way, when the first shear device 1 and the second shear device 2 rotate relative to each other, the slurry stagnated and circulated between the two can be sheared, thereby fully dispersing the slurry. Two shear receiving grooves 14 are provided at intervals in an axial direction based on the first shear device 1 and accommodate one of the shear embedded rings 21 in a one-to-one correspondence, so that the dispersing device can enlarged the volume of the dispersing region (i.e., the volume of the gap between the first shear device 1 and the second shear device 2) of the pulping machine as much as possible in an equal volume space, the volume being a sum of the volume of the first connection gap 3 and the volume of the second connection gap 4, to increase the production capacity of the pulping machine. In addition, according to common knowledge in the art, the larger the volume of the dispersing region of the pulping machine, the longer the residence time of the slurry in the dispersing region, thus facilitating the dispersing device to shear the slurry more fully, so as to further improve the mixing degree of the slurry, that is, further improve the performance of the slurry.

In an embodiment, in order to make the first shear device 1 run more smoothly, the first shear device 1 is an integrally formed structure. Such arrangement also allows a thickness of the annular separation plate 13 to be further reduced, thereby further expanding the volume of the dispersing region of the pulping machine.

In an embodiment, the shear embedded ring 21 and the shear inner ring 11 are provided at intervals to form a first connection gap 3, the shear embedded ring 21 and the shear outer ring 12 are provided at intervals to form a second connection gap 4, and the first radial through hole 111, the first connection gap 3, the second radial through hole 211, the second connection gap 4 and the third radial through hole 121 are communicated in sequence. In this way, the first radial through hole 111, the second radial through hole 211 and the third radial through hole 121 are in a continuous communication state, so that the slurry can be guaranteed to be in a flow state regardless of whether the first radial through hole 111 and the second radial through hole 211 are completely misaligned or not, and the slurry can be guaranteed to be in a flow state regardless of whether the second radial through hole 211 and the third radial through hole 121 are completely misaligned or not.

In an embodiment, an inner side of the shear inner ring 11 is connected with a seal ring 15, and an inner hole of the seal ring 15 is configured to sealingly and interlockingly connect a rotation shaft 6. In this way, the seal ring 15 can cooperate with the rotation shaft 6 to segment a shear chamber of the pulping machine. It can be understood that, as an alternative arrangement, the seal ring 15 can be a part of the rotation shaft 6 and not a part of the dispersing device.

In an embodiment, the second shear device 2 has an annular carrier plate 22 fixedly connected coaxially with the shear embedded ring 21, and the annular carrier plate 22 is configured to connect the pulping machine to support the shear embedded ring 21. In this way, the shear embedded ring 21 can be supported without the need for support by means of the first shear device 1 to maintain a suspended state, and upper and lower ends of the middle part of the dispersing device are all kept to be open structures. In this embodiment, the arrangement is adopted which the first shear device 1 is the shear rotor and the second shear device 2 is the shear stator. In this way, the annular carrier plate 22 can be fixedly connected with a frame 5 of the pulping machine, so that the shear rotor can be fixed to the rotation shaft 6; thus, there is no physical contact between the shear stator and the shear rotor.

In an embodiment, the plurality of the first radial through holes 111 are evenly distributed on a side wall of the shear inner ring 11, the plurality of the second radial through holes 211 are evenly distributed on a side wall of the shear embedded ring 21, and the plurality of the third radial through holes 121 are evenly distributed on a side wall of the shear outer ring 12. Such setting can improve the smoothness of the slurry flow in the pulping machine. In an embodiment, the first radial through hole 111, the second radial through hole 211 and the third radial through hole 121 are all circular hole structures or square hole structures, etc.

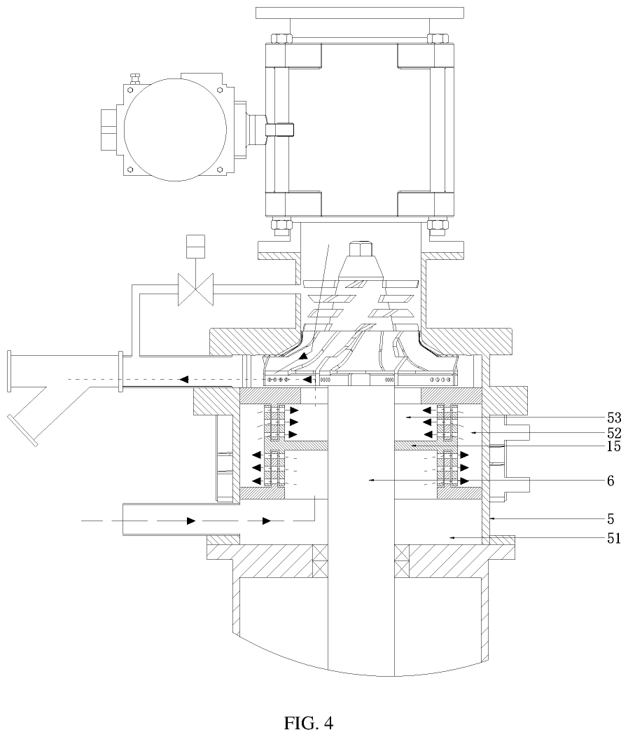

As shown in FIG. 4, the present application also discloses the pulping machine which includes the frame 5, a rotation shaft 6 and the dispersing device. The frame 5 has the shear chamber, the dispersing device is accommodated in the shear chamber, and the rotation shaft 6 passes through the inner hole of the first shear device 1 and is drivingly connected with the first shear device 1. The dispersing device divides the shear chamber into a first chamber 51, a second chamber 52 and a third chamber 53 connected in sequence, and the first chamber 51 and the third chamber 53 are located at both opposite ends of the seal ring 15. In this way, the dispersing device is also a two-layer structure, and the slurry enters the second chamber 52 from the first chamber 51, and then enters the third chamber 53 from the second chamber 52. Only two perforation actions need to be completed, and the total number of turning times is also two, while the number of shearing times reaches four times. In addition, in the case where the volume of the shear chamber of the pulping machine is constant, the diameter of the first connection gap 3 and the second connection gap 4 can be enlarged as much as possible. Therefore, the maximum shearing force can be ensured, so as to make the shearing efficiency higher, thereby greatly improving the dispersion efficiency of the slurry, that is, greatly increasing the production capacity.

It should be noted that both an inlet and an outlet of the pulping machine are connected with a liquid tank (i.e., solvent tank), and external circulation of the slurry is carried out between the two.

The above-mentioned embodiments are only some embodiments of the present application, and cannot be used to limit the protection scope of the present application. Any non-substantive changes and substitutions made by those skilled in the art on the basis of the present application should fall within the scope of the present application.

What is claimed is:

1. A dispersing device, comprising: a first shear device and at least two second shear devices,
wherein one of the first shear device and the second shear device is a shear stator and another one of the first shear device and the second shear device is a shear rotor, and the first shear device is rotatable relative to the second shear device;
wherein the first shear device comprises a shear inner ring, a shear outer ring and an annular isolation board; the shear inner ring is provided with a plurality of first radial through holes provided at intervals from each other; the shear outer ring is provided to surround outside the shear inner ring, and is provided coaxially with the shear inner ring and connected in linkage with each other; the shear outer ring is provided with a plurality of third radial through holes provided at intervals from each other; the annular isolation board is located between the shear inner ring and the shear outer ring, an inner side of the annular isolation board is connected with the shear inner ring, and an outer side of the annular isolation board is connected with the shear outer ring, so that both opposite ends of the annular isolation board form shear receiving grooves, respectively; and
wherein the second shear device has a shear embedded ring, the shear embedded rings of each of the second shear devices are respectively embedded in one of the shear embedded rings, and the shear embedded ring is provided with a plurality of second radial through holes provided at intervals from each other.

2. The dispersing device according to claim 1, wherein the first shear device is an integrally formed structure.

3. The dispersing device according to claim 1, wherein the shear embedded ring and the shear inner ring are provided at intervals to form a first connection gap, the shear embedded ring and the shear outer ring are provided at intervals to form a second connection gap, and the first radial through hole, the first connection gap, the second radial through hole, the second connection gap and the third radial through hole are communicated in sequence.

4. The dispersing device according to claim 1, wherein an inner side of the shear inner ring is connected with a seal ring, and an inner hole of the seal ring is configured to sealingly and interlockingly connect a rotation shaft.

5. The dispersing device according to claim 4, wherein the second shear device has an annular carrier plate fixedly connected with the shear embedded ring coaxially, and the annular carrier plate is configured to connect a pulping machine to support the shear embedded ring.

6. The dispersing device according to claim 5, wherein the first shear device is the shear rotor, and the second shear device is the shear stator.

7. The dispersing device according to claim 1, wherein the plurality of the first radial through holes are evenly distributed on a side wall of the shear inner ring, the plurality of the second radial through holes are evenly distributed on a side wall of the shear embedded ring, and the plurality of the third radial through holes are evenly distributed on a side wall of the shear outer ring.

8. The dispersing device according to claim 1, wherein the first radial through hole, the second radial through hole and the third radial through hole are all circular hole structure.

9. A pulping machine, comprising: a frame, a rotation shaft and the dispersing device according to claim 1, wherein the frame has a shear chamber, the dispersing device is accommodated in the shear chamber, the rotation shaft passes through an inner hole of the first shear device and is drivingly connected with the first shear device, the dispersing device divides the shear chamber into a first chamber, a second chamber and a third chamber connected in sequence, and the first chamber and the third chamber are located at both opposite ends of the seal ring.
